(19) United States
(12) Patent Application Publication
(10) Pub. No.: US 2015/0268568 A1
(43) Pub. Date: Sep. 24, 2015

(54) ELECTROPHOTOGRAPHIC PHOTORECEPTOR, IMAGE FORMING APPARATUS, AND PROCESS CARTRIDGE

(71) Applicant: FUJI XEROX CO., LTD., Tokyo (JP)

(72) Inventors: Yoshifumi SHOJI, Kanagawa (JP); Masahiro IWASAKI, Kanagawa (JP); Jiro KORENAGA, Kanagawa (JP)

(73) Assignee: FUJI XEROX CO., LTD., Tokyo (JP)

(21) Appl. No.: 14/584,565

(22) Filed: Dec. 29, 2014

(30) Foreign Application Priority Data
Mar. 24, 2014 (JP) 2014-060665

(51) Int. Cl. G03G 15/00

(52) U.S. Cl. CPC G03G 5/0662; G03G 5/0614; G03G 5/0618; G03G 5/0609

(57) ABSTRACT

An electrophotographic photoreceptor includes a conductive substrate, and a singlelayer type photosensitive layer that contains a binder resin (A), a charge generating material (B), a positive hole transporting material (C), an electron transporting material (D) whose content is in a range of 10% by weight to 40% by weight with respect to the binder resin (A) and which is represented by the following formula (d), and a terphenyl compound (E):

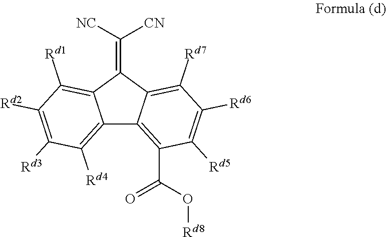

wherein in the formula (d), R^{d1}, R^{d2}, R^{d3}, R^{d4}, R^{d5}, R^{d6}, and R^{d7} each independently represent a hydrogen atom, a halogen atom, an alkyl group, an alkoxy group, an aralkyl group, or an aryl group; and R^{d8} represents an aralkyl group or an alkyl group.

### CROSS-REFERENCE TO RELATED APPLICATIONS

This application is based on and claims priority under 35 USC 119 from Japanese Patent Application No. 2014-060665 filed Mar. 24, 2014.

### BACKGROUND

1. Technical Field

The present invention relates to an electrophotographic photoreceptor, an image forming apparatus, and a process cartridge.

2. Related Art

In an image forming apparatus having an electrophotographic system in the related art, a toner image formed on the surface of an electrophotographic photoreceptor is transferred to a recording medium through a process of charging, exposing, developing, and transferring.

It is known that a charge transporting material with improved charge transporting ability is used for a photosensitive layer of an electrophotographic photoreceptor applied to such an image forming apparatus having an electrophotographic system.

### SUMMARY

According to an aspect of the invention, there is provided an electrophotographic photoreceptor including:

a conductive substrate; and

a singlelayer type photosensitive layer that contains a binder resin (A), a charge generating material (B), a positive hole transporting material (C), an electron transporting material (D) whose content is in a range of 10% by weight to 40% by weight with respect to the binder resin (A) and which is represented by the following formula (d), and a terphenyl compound (E):

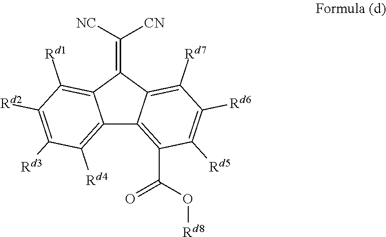

wherein in the formula (d), R^{d1}, R^{d2}, R^{d3}, R^{d4}, R^{d5}, R^{d6}, and R^{d7} each independently represent a hydrogen atom, a halogen atom, an alkyl group, an alkoxy group, an aralkyl group, or an aryl group; and R^{d8} represents an aralkyl group or an alkyl group.

### BRIEF DESCRIPTION OF THE DRAWINGS

Exemplary embodiments of the present invention will be described in detail based on the following figures, wherein:

FIG. 1 is a partial cross-sectional view schematically illustrating an example of an electrophotographic photoreceptor according to the present exemplary embodiment;

FIG. 2 is a view schematically illustrating a configuration of an image forming apparatus according to the present exemplary embodiment; and

FIG. 3 is a view schematically illustrating a configuration of another image forming apparatus according to the present exemplary embodiment.

### DETAILED DESCRIPTION

Hereinafter, exemplary embodiments which are examples of the present invention will be described.

<Electrophotographic Photoreceptor>

An electrophotographic photoreceptor according to the present exemplary embodiment includes a conductive substrate, a binder resin (A), a charge generating material (B), a positive hole transporting material (C), an electron transporting material (D) whose content is in the range of 10% by weight to 40% by weight with respect to the binder resin (A) and which is represented by the formula (d) described below, and a singlelayer type photosensitive layer containing a terphenyl compound (E).

That is, such an electrophotographic photoreceptor is a positively charged organic photoreceptor (hereinafter, also referred to as a “singlelayer type photoreceptor,” or a “photoreceptor”) including a conductive substrate and a singlelayer type photosensitive layer containing the above-described (A) to (E) components on the conductive substrate.

In addition, the singlelayer type photosensitive layer is a photosensitive layer having charge generating ability, positive hole transporting ability, and electron transporting ability.

Here, from viewpoints of production cost and image quality stability, it is known that a photoreceptor (singlelayer type photoreceptor) including a singlelayer type photosensitive layer is desirable as an electrophotographic photoreceptor used for an image forming apparatus.

Since the charge generating material, the positive hole transporting material, and the electron transporting material are contained in the singlelayer type photosensitive layer, the singlelayer type photoreceptor may not obtain sensitivity similar to that of an organic photoreceptor having a multilayer type photosensitive layer, and accordingly, further improvement in sensitivity is required.

For this reason, a method of realizing high sensitivity of the singlelayer type photoreceptor by means of using a positive hole transporting substance and an electron transporting substance with a high charge transporting property is known.

However, a phenomenon in which the conductive substrate is corroded occurs by applying processes of charging, exposing, developing, and transferring to the electrophotographic photoreceptor having improved sensitivity by improving the charge transporting property at a high temperature and high humidity (for example, room temperature of 32° C. and a humidity of 85%). It is considered that the phenomenon occurs because an electrochemical reaction is generated between the electron transporting material having a structure with an excellent charge transporting property and the conductive substrate or the electrochemical reaction is accelerated.

In the electrophotographic photoreceptor according to the present exemplary embodiment, the electron transporting material (D) which has an excellent charge transporting property and is represented by the formula (d) and the terphenyl compound (E) are present in the singlelayer type photosensitive layer together with the binder resin (A), the charge generating material (B), and the positive hole transporting material (C).

Particularly, an electron trap is reduced and the leakage of electrons is prevented when the electron transporting material (D) represented by the formula (d) is contained in the singlelayer type photosensitive layer in a specific content, and thus, generation of color points on an image is prevented and improvement in sensitivity is achieved. Further, it is considered that the electrochemical reaction between the electron transporting material and the conductive substrate may be prevented and the corrosion of the conductive substrate may be prevented by allowing the electron transporting material (D) represented by the formula (d) and the terphenyl compound (E) to coexist in the singlelayer type photosensitive layer, although the reason is not clear.

In addition, in the related art, a technique of preventing cracks (a phenomenon of cracks generated in the photosensitive layer containing a resin, so-called “chemical crack”) generated on the photosensitive layer of the electrophotographic photoreceptor and of preventing generation of color points in an image by adding a terphenyl compound is known.

Even in the electrophotographic photoreceptor according to the present exemplary embodiment, when the singlelayer type photosensitive layer contains the terphenyl compound (E), corrosion of the conductive substrate may be prevented as described above and chemical cracks may be prevented.

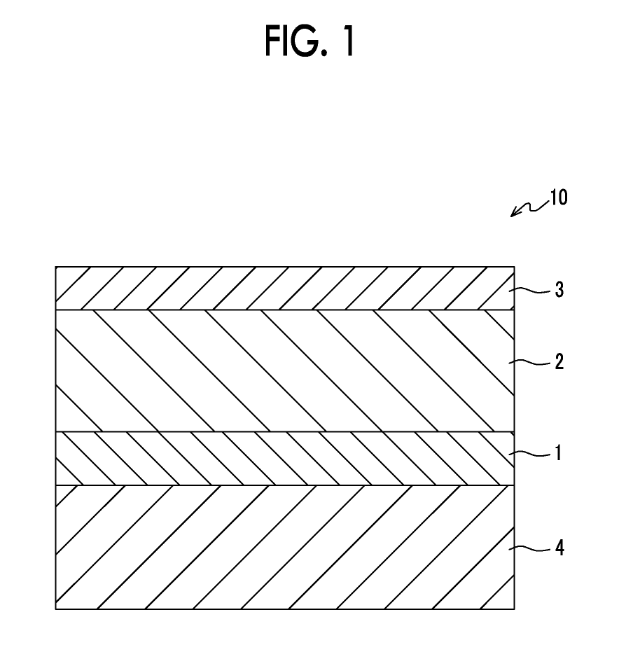

Hereinafter, the configuration of the electrophotographic photoreceptor will be described with reference to FIG. 1.

Here, FIG. 1 a partial cross-sectional view schematically illustrating an example of the electrophotographic photoreceptor according to the present exemplary embodiment.

An electrophotographic photoreceptor 10 illustrated in FIG. 1 includes a conductive substrate 4 and is configured such that an undercoat layer 1, a singlelayer type photosensitive layer 2, and a protective layer 3 are provided on the conductive substrate 4 in this order.

Further, the undercoat layer 1 and the protective layer 3 are layers provided according to the necessity.

Hereinafter, each of components of the electrophotographic photoreceptor 10 will be described. In the description, reference numerals will be omitted.

[Conductive Substrate]

Examples of the conductive substrate include a metal plate, a metal drum, and a metal belt containing a metal (aluminum, copper, zinc, chromium, nickel, molybdenum, vanadium, indium, gold, or platinum) or an alloy (stainless steel or the like). Further, examples of the conductive substrate include paper, a resin film, and a belt on which a conductive compound (for example, a conductive polymer or indium oxide), a metal (for example, aluminum, palladium or gold), or an alloy is applied, deposited or laminated. Here, the “conductivity” means that the volume resistivity is less than 10¹³ Ωcm.

For a purpose of preventing interference fringe generated at the time of application of laser light, it is preferable that the surface of the conductive substrate be roughened such that the center line average roughness Ra is in the range of 0.04 μm to 0.5 μm in a case where the electrophotographic photoreceptor is used for a laser printer. Further, in a case where non-interference light is used for a light source, roughening the surface for preventing interference fringe is not particularly necessary, but roughening the surface is suitable for elongation of life because generation of defects due to unevenness of the surface of the conductive substrate is prevented.

Examples of the roughening method include wet honing of suspending a polishing agent in water and blowing the suspension to a support; centerless grinding of pressure-contacting a conductive substrate to a rotating grindstone and continuously performing a grinding process; and an anode oxidation treatment.

As the roughening method, a method of dispersing conductive or semi-conductive powder in a resin, forming a layer on a surface of a conductive substrate, and performing roughening the layer using particles dispersed in the layer not roughening the surface of the conductive substrate.

The roughening process using anode oxidation is a process of forming an oxide film on a surface of a conductive substrate using a metal (for example, made of aluminum) conductive substrate as an anode to be anode-oxidized in an electrolyte solution. Examples of the electrolyte solution include a sulfuric acid solution and an oxalic acid solution. However, a porous anode oxide film formed by anode oxidation is chemically active as it is and easily contaminated, and resistance fluctuation thereof due to the environment is large. Therefore, it is preferable that a sealing treatment of sealing micropores of an oxide film through volume expansion using a hydration reaction in pressurized steam or boiled water (metal salts of nickel or the like may be added) and changing the oxide film into a more stable hydrated oxide be performed with respect to a porous anode oxide film.

The film thickness of the anode oxide film is preferably in the range of 0.3 μm to 15 μm. When the film thickness is in the above-described range, there is a tendency that a barrier property against injection is exhibited and an increase in residual potential due to repeated use is prevented.

The conductive substrate may be subjected to a treatment using an acidic treatment solution or a boehmite treatment.

The treatment using an acidic treatment solution is performed as follows. First, an acidic treatment solution containing phosphoric acid, chromic acid, and hydrofluoric acid is prepared. The mixing ratio of phosphoric acid, chromic acid, and hydrofluoric acid in the acidic treatment solution is phosphoric acid of 10% by weight to 11% by weight, chromic acid of 3% by weight to 5% by weight, and hydrofluoric acid of 0.5% by weight to 2% by weight. Further, the concentration of the entire acids may preferably be in the range of 13.5% by weight to 18% by weight. The treatment temperature is preferably in the range of 42° C. to 48° C. The film thickness of the coating film is preferably in the range of 0.3 μm to 15 μm.

The boehmite treatment is performed by immersing the conductive substrate in pure water in the temperature range of 90° C. to 100° C. for 5 minutes to 60 minutes or by bringing the conductive substrate into contact with heated steam in the temperature range of 90° C. to 120° C. for 5 minutes to 60 minutes. The film thickness of the coating film is preferably in the range of 0.1 μm to 5 μm. The film may further be subjected to an anode oxide treatment using an electrolyte solution with low coating solubility such as adipic acid, boric acid, borate, phosphate, phthalate, maleate, benzoate, tartrate, or citrate.

[Undercoat Layer]

An undercoat layer is a layer containing inorganic particles and a binder resin.

As inorganic particles, inorganic particles having a powder resistance (volume resistivity) of 10² Ωcm to 10¹¹ Ωcm are exemplified.

Among these, as inorganic particles having the above-described resistance value, metal oxide particles such as tin oxide particles, titanium oxide particles, zinc oxide particles, or zirconium oxide particles are preferable and zinc oxide particles are particularly preferable.

The specific surface area of the inorganic particles using a BET method may preferably be 10 m²/g or more.

The volume average particle diameter of the inorganic particles may be in the range of 50 nm to 2000 nm (preferably in the range of 60 nm to 1000 nm).

The content of the inorganic particles is preferably in the range of 10% by weight to 80% by weight and more preferably in the range of 40% by weight to 80% by weight with respect to the binder resin.

The inorganic particles may be subjected to a surface treatment. The inorganic particles may be used in combination of two or more kinds of particles which are subjected to different surface treatments or particles whose particle diameters are different from one another.

Examples of a surface treatment agent include a silane coupling agent, a titanate-based coupling agent, an aluminum-based coupling agent, and a surfactant. Particularly, a silane coupling agent is preferable and a silane coupling agent having an amino group is preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but the examples are not limited thereto.

The silane coupling agent may be used in combination of two or more kinds thereof. For example, a silane coupling agent having an amino group and another silane coupling agent may be combined with each other. Examples of another silane coupling agent include vinyl trimethoxy silane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but the examples are not limited thereto.

As a surface treatment method using a surface treatment agent, any method may be used as long as the method is a known method, and any one of a dry method and a wet method may be used.

A treatment amount of the surface treatment agent is preferably in the range of 0.5% by weight to 10% by weight with respect to inorganic particles.

Here, from viewpoints of long term stability of electrical characteristics and improvement in carrier blocking property, it is preferable that an undercoat layer contain inorganic particles and an electron accepting compound (acceptor compound).

Examples of the electron accepting compound include electron transporting substances, for example, a quinone-based compound such as chloranil or bromanil; a tetracyanoquinodimethane-based compound; a fluorenone compound such as 2,4,7-trinitrofluorenone or 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone.

Particularly, a compound having an anthraquinone structure is preferable as the electron accepting compound. As the compound having an anthraquinone structure, for example, a hydroxyanthraquinone compound, an aminoanthraquinone compound, or an aminohydroxyanthraquinone compound is preferable, and specifically, anthraquinone, alizarin, quinizarine, anthrarufin, or purpurin is preferable.

The electron accepting compound may be contained in the undercoat layer in a state of being dispersed in the undercoat layer together with inorganic particles or in a state of being adhered to the surface of inorganic particles.

As a method of adhering the electron accepting compound onto the surface of inorganic particles, a dry method or a wet method may be exemplified.

The dry method is a method of directly dropping an electron accepting compound or dropping the electron accepting compound dissolved in an organic solvent while inorganic particles are stirred using a mixer or the like having large shearing force, spraying the electron accepting compound together with dry air or nitrogen gas, and adhering the electron accepting compound to the surface of inorganic particles. Dropping or spraying the electron accepting compound may preferably be performed at a temperature lower than or equal to the boiling point of a solvent. The electron accepting compound may be baked at a temperature of 100° C. or higher after being dropped or sprayed. The baking is not particularly limited as long as the baking is performed under a condition of a temperature and a time period which are the same as those of the condition for which electrophotographic characteristics may be obtained.

The wet method is a method of dispersing inorganic particles in a solvent using stirring, an ultrasonic wave, a sand mill, an attritor, or a ball mill, adding an electron accepting compound thereto, stirring the mixture or dispersing the compound in the mixture, removing a solvent, and adhering the electron accepting compound to the surface of the inorganic particles. In the solvent removing method, the solvent is distilled by filtration or distillation. After the solvent is removed, the resultant may be baked at a temperature of 100° C. or higher. The baking is not particularly limited as long as the baking is performed under a condition of a temperature and a time period which are the same as those of the condition for which electrophotographic characteristics may be obtained. In the wet method, the moisture contained in the inorganic particles may be removed before the electron accepting compound is added, and examples thereof include a method of removing the moisture while performing stirring and heating the solvent and a method of boiling the moisture with the solvent and removing the moisture.

In addition, the electron accepting compound may be attached to the surface of the inorganic particles before or after the surface treatment using a surface treatment agent is applied to the inorganic particles, and adhesion of the electron accepting compound and the surface treatment using a surface treatment agent may be performed at the same time.

The content of the electron accepting compound may be in the range of 0.01% by weight to 20% by weight and preferably in the range of 0.01% by weight to 10% by weight with respect to the inorganic particles.

Examples of the binder resin used for the undercoat layer include known polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic acid anhydride resin, a silicone resin, a silicone-alkyd resin, a urea resin, a phenol resin, a phenol-formaldehyde resin, a melamine resin, a urethane resin, an alkyd resin, and an epoxy resin, and known materials such as a zirconium chelate compound, a titanium chelate compound, an aluminum chelate compound, a titanium alkoxide compound, an organic titanium compound, and a silane coupling agent.

As the binder resin used for the undercoat layer, a charge transporting resin including a charge transporting group or a conductive resin (for example, polyaniline) may be exemplified.

Among these, as the binder resin used for the undercoat layer, a resin which is insoluble in a coating solvent of the upper layer is preferable, and thermosetting resins such as a urea resin, a phenol resin, a phenol-formaldehyde resin, a melamine resin, a urethane resin, an unsaturated polyester resin, an alkyd resin, and an epoxy resin; and a resin obtained by a reaction between a curing agent and at least one kind of resin selected from a group consisting of a polyamide resin, a polyester resin, a polyether resin, a methacrylic resin, an acrylic resin, a polyvinyl alcohol resin, and a polyvinyl acetal resin are particularly preferable.

In a case where these binder resins are used in a combination of two or more kinds thereof, the mixing ratio is set according to the necessity.

The undercoat layer may contain various additives for improvement in electrical characteristics, environmental stability, and image quality.

Examples of the additive include known materials, for example, electron transporting pigments such as a polycyclic condensed material and an azo-based material, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be added to the undercoat layer as an additive.

Examples of the silane coupling agent as an additive include vinyl trimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethylmethoxysilane, N,N-bis(2-hydroxyethyl)-3-aminopropyltriethoxysilane, and 3-chloropropyltrimethoxysilane.

Examples of the zirconium chelate compound include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octonate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compound include tetraisopropyl titanate, tetra-n-butyl titanate, butyl titanate dimer, tetra(2-ethylhexyl)titanate, titanium acetylacetonate, polytitanium acetylacetonate, titanium octylene glycolate, titanium lactate ammonium salts, titanium lactate, titanium lactate ethyl ester, titanium triethanolaminate, and polyhydroxy titanium stearate.

Examples of the aluminum chelate compound include aluminum isopropylate, monobutoxy aluminum diisopropylate, aluminum butylate, diethyl acetoacetate aluminum diisopropylate, and aluminum tris(ethylacetoacetate).

These additives may be used alone, in combination of plural compounds, or as a polycondensate.

The Vickers hardness of the undercoat layer may preferably be 35 or more.

It is preferable that the surface roughness (ten-point average roughness) of the undercoat layer be adjusted to be from ¼n (n is a refractive index of the upper layer) to ½λ of a laser wavelength λ for exposure to be used for a purpose of prevention of a moire image.

Resin particles or the like may be added to the undercoat layer for adjustment of surface roughness. As the resin particles, silicone resin particles and cross-linked polymethacrylic acid methyl resin particles may be exemplified. Further, the surface of the undercoat layer may be polished for adjustment of the surface roughness. As the polishing method, buff polishing, sand blast polishing, wet honing, or a grinding process may be exemplified.

Formation of the undercoat layer is not particularly limited and a known formation method is used. For example, the undercoat layer may be formed by forming a coated film with a coating liquid for forming an undercoat layer which is obtained by adding the above-described components to the solvent, drying the coated film, and heating the dried film if necessary.

Examples of the solvent for preparing the coating liquid for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include normal organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

As a method of dispersing inorganic particles at the time of preparing a coating liquid for forming an undercoat layer include known methods such as a roll mill, a ball mill, a vibration ball mill, an attritor, a sand mill, a colloid mill, and a paint shaker.

Examples of a method of coating the conductive substrate with a coating liquid for forming an undercoat layer include normal methods such as a blade coating method, a wire bar coating method, a spray coating method, a dipping coating method, a bead coating method, an air knife coating method, and a curtain coating method.

The film thickness of the undercoat layer is set to preferably 15 μm or more and more preferably in the range of 20 μm to 50 μm.

[Intermediate Layer]

The illustration is omitted, but an intermediate layer may be further provided between the undercoat layer and the photosensitive layer.

For example, the intermediate layer is a layer containing a resin. Examples of the resin used for the intermediate layer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic acid anhydride resin, a silicone resin, a silicone-alkyd resin, a phenol-formaldehyde resin, and a melamine resin.

The intermediate layer may be a layer containing an organic metal compound. Examples of the organic metal compound used for the intermediate layer include an organic metal compound containing metal atoms such as zirconium, titanium, aluminum, manganese, and silicon.

These compounds used for the intermediate layer may be used alone, in combination of plural compounds, or as a polycondensate.

Among these, it is preferable that the intermediate layer be a layer containing an organic metal compound containing zirconium atoms or silicon atoms.

Formation of the intermediate layer is not particularly limited and a known formation method is used. For example, the intermediate layer may be formed by forming a coated film with a coating liquid for forming an intermediate layer which is obtained by adding the above-described components to the solvent, drying the coated film, and heating the dried film if necessary.

Examples of a coating method of forming an intermediate layer include normal methods such as a dipping coating method, an extrusion coating method, a wire bar coating method, a spray coating method, a blade coating method, a knife coating method, and a curtain coating method.

The film thickness of the intermediate layer is preferably set in the range of 0.1 μm to 3 μm. Further, the intermediate layer may be used as the undercoat layer.

[Singlelayer Type Photosensitive Layer]

The singlelayer type photosensitive layer contains a binder resin (A), a charge generating material (B), a positive hole transporting material (C), an electron transporting material (D) represented by the formula (d), and a terphenyl compound (E); and other additives if necessary.

[Binder Resin (A)]

Examples of the binder resin, which are not particularly limited, include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic acid anhydride copolymer, a silicone resin, a silicone alkyd resin, a phenol-formaldehyde resin, a styrene-alkyd resin, a poly-N-vinylcarbazole, and polysilane. These binder resins may be used alone or in combination of two or more kinds thereof.

Particularly, from a viewpoint of a film forming property of a photosensitive layer, for example, a polycarbonate resin having a viscosity average molecular weight of 30000 to 80000 is preferable among these binder resins.

In terms of productivity and film strength, the content of the binder resin is in the range of 35% by weight to 60% by weight and preferably in the range of 20% by weight to 35% by weight with respect to the total weight of the photosensitive layer (weight of the solid content).

[Charge Generating Material (B)]

As the charge generating material, a known charge generating material used for an electrophotographic photoreceptor, for example, an azo pigment such as bisazo or trisazo; a condensed aromatic pigment such as dibromoanthanthrone; a perylene pigment; a pyrrolopyrrole pigment; a phthalocyanine pigment; zinc oxide; or trigonal selenium is applied.

Among these, in terms of high sensitivity of the photoreceptor or dispersion of the charge generating material, it is preferable that at least one kind selected from a hydroxy gallium phthalocyanine pigment and a chloro gallium phthalocyanine pigment be applied as the charge generating material.

As the charge generating material, these pigments may be used alone or in combination if necessary. In addition, from viewpoints of high sensitivity of the photoreceptor and preventing point defects of an image, a hydroxy gallium phthalocyanine pigment is preferable as the charge generating material.

As the hydroxy gallium phthalocyanine pigment, although there is no particular limitation, a V-shaped hydroxy gallium phthalocyanine pigment is preferable.

Particularly, in a spectral absorption spectrum in a wavelength region of 600 nm to 900 nm, for example, a hydroxy gallium phthalocyanine pigment having a maximum peak wavelength in the range of 810 nm to 839 nm is preferable for the hydroxy gallium phthalocyanine pigment from a viewpoint of obtaining more excellent dispersibility. In a case where the hydroxy gallium phthalocyanine pigment is used as a material of the electrophotographic photoreceptor, excellent dispersibility, sufficient sensitivity, a charging property, and dark decay characteristics may be easily obtained.

Further, the average particle diameter of the hydroxy gallium phthalocyanine pigment having a maximum peak wavelength in the range of 810 nm to 839 nm has a specific range, and it is preferable that the BET specific surface area thereof have a specific range. Specifically, the average particle diameter thereof is preferably 0.20 μm or less and more preferably in the range of 0.01 μm to 0.15 μm; and the BET specific surface area thereof is preferably 45 m²/g or more, more preferably 50 m²/g or more, and particularly preferably in the range of 55 m²/g to 120 m²/g. The average particle diameter is a volume average particle diameter (d50 average particle diameter) and a value measured by a laser diffraction scattering particle size distribution measuring device (LA-700, manufactured by Horiba, Ltd.). Further, the average particle diameter is a value measured by a BET type specific surface area measuring instrument (Flow Soap II2300, manufactured by Shimadzu Corporation) using a nitrogen substitution method.

Here, in a case where the average particle diameter is greater than 0.20 μm or the specific surface area thereof is less than 45 m²/g, there is a tendency that pigment particles are coarsened or an aggregate of the pigment particles is formed. Further, defects tend to be easily generated in the dispersibility, the sensitivity, the charging property, and the dark decay characteristics, and as a result, image quality defects are easily generated in some cases.

The maximum particle diameter (the maximum value of a primary particle diameter) of the hydroxy gallium phthalocyanine pigment is preferably 1.2 μm or less, more preferably 1.0 μm or less, and still more preferably 0.3 μm or less. When such a maximum particle diameter exceeds the above-described range, black spots tend to be easily generated.

From a viewpoint of preventing concentration unevenness caused by the photoreceptor being exposed to a fluorescent lamp or the like, it is preferable that the hydroxy gallium phthalocyanine pigment have an average particle diameter of 0.2 μm or less, a maximum particle diameter of 1.2 μm or less, and a specific surface area of 45 m²/g or more.

In an X-ray diffraction spectrum using a CuKα characteristic X-ray, the hydroxy gallium phthalocyanine pigment preferably has a V shape with diffraction peaks at least at bragg angles (2θ±0.2°) of 7.3°, 16.0°, 24.9°, and 28.0°.

Further, although there is no particular limitation, a chloro gallium phthalocyanine pigment preferably has diffraction peaks at bragg angles (2θ±0.2°) of 7.4°, 16.6°, 25.5°, and 28.3° with which excellent sensitivity for a material of the electrophotographic photoreceptor may be obtained.

The maximum peak wavelength, the average particle diameter, the maximum particle diameter, and the specific surface area of a preferable spectral absorption spectrum of the chloro gallium phthalocyanine pigment are the same as those of the hydroxy gallium phthalocyanine pigment.

The content of the charge generating material is in the range of 0.05% by weight to 30% by weight, preferably in the range of 1% by weight to 15% by weight, and more preferably in the range of 2% by weight to 10% by weight with respect to the binder resin.

[Positive Hole Transporting Material (C)]

As the positive hole transporting material, a known positive hole transporting material used for the electrophotographic photoreceptor such as a triarylamine-based compound, a benzidine-based compound, an arylalkane-based compound, an aryl-substituted ethylene-based compound, a stilbene-based compound, an anthracene-based compound, or a hydrazone-based compound is applied.

Among these, in terms of high sensitivity of the photoreceptor, at least one of a compound represented by the following formula (c1), a compound represented by the following formula (c2), and a compound represented by the following formula (c3) is preferable as the positive hole transporting material.

In terms of high sensitivity of the photoreceptor and charge mobility, it is preferable that a positive hole transporting material represented by the following formula (c1) be applied as the positive hole transporting material of the present exemplary embodiment.

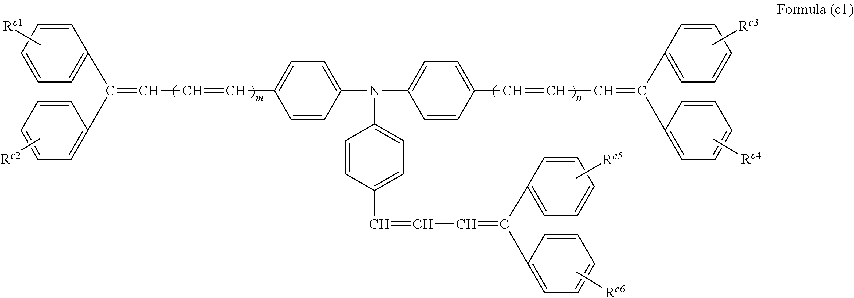

In the formula (c1), R^{c1}, R^{c2}, R^{c3}, R^{c4}, R^{c5}, and R^{c6} each independently represent a hydrogen atom, an alkyl group, an alkoxy group, a phenoxy group, a halogen atom, or a phenyl group that may have a substituent selected from an alkyl group, an alkoxy group, and a halogen atom. m and n each independently represent 0 or 1.

In the formula (c1), as the alkyl group represented by R^{c1} to R^{c6}, a lower alkyl group which is linear or branched and has 1 to 4 carbon atoms may be exemplified, and specific examples thereof include a methyl group, an ethyl group, an n-propyl group, an isopropyl group, an n-butyl group, and an isobutyl group.

Among these, a methyl group or an ethyl group is preferable as the alkyl group.

In the formula (c1), as the alkoxy group represented by R^{c1} to R^{c6}, an alkoxy group having 1 to 4 carbon atoms is exemplified, and specific examples thereof include a methoxy group, an ethoxy group, a propoxy group, and a butoxy group.

In the formula (c1), as the halogen atom represented by R^{c1} to R^{c6}, a fluorine atom, a chlorine atom, a bromine atom, or an iodine atom may be exemplified.

In the formula (c1), examples of the phenyl group represented by R^{c1} to R^{c6} include a unsubstituted phenyl group; an alkyl group-substituted phenyl group such as a p-tolyl group or a 2,4-dimethylphenyl group; an alkoxy group-substituted phenyl group such as a p-methoxyphenyl group; and a halogen atom-substituted phenyl group such as a p-chlorophenyl group.

Further, examples of a substituent which may be substituted with a phenyl group include an alkyl group represented by R^{c1} to R^{c6}, an alkoxy group, and a halogen atom.

From viewpoints of high sensitivity and preventing point defects of an image, a positive hole transporting material in which m and n each independently represent 1 is preferable as the positive hole transporting material represented by the formula (c1), and a positive hole transporting material in which R^{c1} to R^{c6} each independently represent a hydrogen atom, an alkyl group, or an alkoxy group; and m and n each independently represent 1 is particularly preferable as the positive hole transporting material represented by the formula (c1).

Hereinafter, compounds (c1-1) to (c1-64) will be shown as examples of the positive hole transporting material represented by the formula (c1), but the exemplary embodiments are not limited thereto.

| Example | | | | | | | | |
|---|---|---|---|---|---|---|---|---|
| Com- | | | | | | | | |
| pound | m | n | R^{c1} | R^{c2} | R^{c3} | R^{c4} | R^{c5} | R^{c6} |
| (c1-1) | 1 | 1 | H | H | H | H | H | H |
| (c1-2) | 1 | 1 | 4—Me | 4—Me | 4—Me | 4—Me | 4—Me | 4—Me |
| (c1-3) | 1 | 1 | 4—Me | 4—Me | H | H | 4—Me | 4—Me |
| (c1 -4) | 1 | 1 | 4—Me | H | 4—Me | H | 4—Me | H |
| (c1-5) | 1 | 1 | H | H | 4—Me | 4-Me | H | H |
| (c1-6) | 1 | 1 | 3—Me | 3—Me | 3—Me | 3—Me | 3—Me | 3—Me |
| (c1-7) | 1 | 1 | H | H | H | H | 4-CI | 4-CI |
| (c1 -8) | 1 | 1 | 4—MeO | H | 4—MeO | H | 4—MeO | H |
| (c1-9) | 1 | 1 | H | H | H | H | 4—MeO | 4—MeO |
| (c1-10) | 1 | 1 | 4—MeO | 4—MeO | 4—MeO | 4—MeO | 4—MeO | 4—MeO |
| (c1-11) | 1 | 1 | 4—MeO | H | 4—MeO | H | 4—MeO | 4—MeO |
| (c1-12) | 1 | 1 | 4—Me | H | 4—Me | H | 4—Me | 4-F |
| (c1-13) | 1 | 1 | 3—Me | H | 3—Me | H | 3—Me | H |
| (c1-14) | 1 | 1 | 4—Cl | H | 4-Cl | H | 4—Cl | H |
| (c1-15) | 1 | 1 | 4—Cl | 4—Cl | 4—Cl | 4—Cl | 4—Cl | 4—Cl |
| (c1-16) | 1 | 1 | 3—Me | 3—Me | 3—Me | 3—Me | 3—Me | 3—Me |
| (c1-17) | 1 | 1 | 4—Me | 4—MeO | 4—Me | 4—MeO | 4—Me | 4—MeO |
| (c1-18) | 1 | 1 | 3—Me | 4—MeO | 3—Me | 4—MeO | 3—Me | 4—MeO |
| (c1-19) | 1 | 1 | 3—Me | 4—Cl | 3—Me | 4—Cl | 3—Me | 4—Cl |
| (c1-20) | 1 | 1 | 4—Me | 4—Cl | 4—Me | 4—Cl | 4—Me | 4—Cl |
| Example | | | | | | | | |
| Com- | | | | | | | | |
| pound | m | n | R¹ | R² | R³ | R⁴ | R⁵ | R⁶ |
| (c1-21) | 1 | 0 | H | H | H | H | H | H |
| (c1-22) | 1 | 0 | 4—Me | 4—Me | 4—Me | 4—Me | 4—Me | 4—Me |
| (c1-23) | 1 | 0 | 4—Me | 4—Me | H | H | 4—Me | 4—Me |
| (c1-24) | 1 | 0 | H | H | 4—Me | 4—Me | H | H |
| (c1-25) | 1 | 0 | H | H | 3—Me | 3—Me | H | H |
| (c1-26) | 1 | 0 | H | H | 4—Cl | 4-Cl | H | H |
| (c1-27) | 1 | 0 | 4—Me | H | H | H | 4—Me | H |
| (c1-28) | 1 | 0 | 4—MeO | H | H | H | 4—MeO | H |
| (c1-29) | 1 | 0 | H | H | 4—MeO | 4—MeO | H | H |
| (c1-30) | 1 | 0 | 4—MeO | 4—MeO | 4—MeO | 4—MeO | 4—MeO | 4—MeO |
| (c1-31) | 1 | 0 | 4—Me0 | H | 4—MeO | H | 4—MeO | 4—MeO |
| (c1-32) | 1 | 0 | 4—Me | H | 4—Me | H | 4—Me | 4—F |
| (c1-33) | 1 | 0 | 3—Me | H | 3—Me | H | 3—Me | H |
| (c1-34) | 1 | 0 | 4—Cl | H | 4—Cl | H | 4-Cl | H |
| (c1-35) | 1 | 0 | 4—Cl | 4—Cl | 4—Cl | 4—Cl | 4—Cl | 4—Cl |
| (c1-36) | 1 | 0 | 3—Me | 3—Me | 3—Me | 3-Me | 3—Me | 3—Me |
| (c1-37) | 1 | 0 | 4—Me | 4—MeO | 4—Me | 4—MeO | 4—Me | 4—MeO |
| (c1-38) | 1 | 0 | 3—Me | 4—MeO | 3—Me | 4—MeO | 3—Me | 4—MeO |
| (c1-39) | 1 | 0 | 3—Me | 4—Cl | 3—Me | 4—Cl | 3—Me | 4—Cl |
| (c1-40) | 1 | 0 | 4—Me | 4—Cl | 4-Me | 4-Cl | 4—Me | 4—Cl |
| (c1-41) | 0 | 0 | H | H | H | H | H | H |
| (c1-42) | 0 | 0 | 4—Me | 4—Me | 4—Me | 4-Me | 4—Me | 4—Me |
| (c1-43) | 0 | 0 | 4—Me | 4—Me | 4—Me | 4-Me | H | H |
| (c1-44) | 0 | 0 | 4—Me | H | 4—Me | H | H | H |
| (c1-45) | 0 | 0 | H | H | H | H | 4—Me | 4—Me |
| (c1-46) | 0 | 0 | 3—Me | 3—Me | 3—Me | 3—Me | H | H |
| (c1-47) | 0 | 0 | H | H | H | H | 4—Cl | 4—Cl |
| (c1-48) | 0 | 0 | 4—MeO | H | 4-MeO | H | H | H |
| (c1-49) | 0 | 0 | H | H | H | H | 4—MeO | 4—MeO |
| (c1-50) | 0 | 0 | 4—MeO | 4—MeO | 4—MeO | 4-MeO | 4—MeO | 4—MeO |
| (c1-51) | 0 | 0 | 4—MeO | H | 4—MeO | H | 4—MeO | 4—MeO |
| (c1-52) | 0 | 0 | 4—Me | H | 4—Me | H | 4—Me | 4—F |
| (c1-53) | 0 | 0 | 3—Me | H | 3—Me | H | 3—Me | H |
| (c1-54) | 0 | 0 | 4—Cl | H | 4—Cl | H | 4—Cl | H |
| (c1-55) | 0 | 0 | 4—Cl | 4—Cl | 4—Cl | 4-Cl | 4-Cl | 4—Cl |
| (c1-56) | 0 | 0 | 3—Me | 3—Me | 3—Me | 3-Me | 3-Me | 3—Me |
| (c1-57) | 0 | 0 | 4—Me | 4—MeO | 4—Me | 4-MeO | 4-Me | 4—MeO |
| (c1-58) | 0 | 0 | 3—Me | 4—MeO | 3—Me | 4-MeO | 3-Me | 4—MeO |
| (c1-59) | 0 | 0 | 3—Me | 4—Cl | 3—Me | 4-Cl | 3-Me | 4—Cl |
| (c1-60) | 0 | 0 | 4—Me | 4—Cl | 4—Me | 4-Cl | 4-Me | 4—Cl |
| (c1-61) | 1 | 1 | 4—Pr | 4—Pr | 4—Pr | 4—Pr | 4—Pr | 4—Pr |
| (c1-62) | 1 | 1 | 4—PhO | 4—PhO | 4—PhO | 4—PhO | 4—PhO | 4—PhO |
| (c1-63) | 1 | 1 | H | 4—Me | H | 4—Me | H | 4—Me |
| (c1-64) | 1 | 1 | 4—C₆H₅ | 4—C₆H₅ | 4—C₆H₅ | 4—C₆H₅ | 4—C₆H₅ | 4—C₆H₅ |

In addition, the abbreviations in the compounds shown above indicate the following meanings.

4-Me: a methyl group substituted on a 4-position of a phenyl group

3-Me: a methyl group substituted on a 3-position of a phenyl group

4-Cl: a chlorine atom substituted on a 4-position of a phenyl group

4-MeO: a methoxy group substituted on a 4-position of a phenyl group

4-F: a fluorine atom substituted on a 4-position of a phenyl group

4-Pr: a propyl group substituted on a 4-position of a phenyl group

4-PhO: a phenoxy group substituted on a 4-position of a phenyl group

In addition, from a viewpoint of charge mobility, a compound (triarylamine derivative) represented by the following formula (c2) and a compound (benzidine derivative) represented by the following formula (c3) are preferable for the positive hole transporting material.

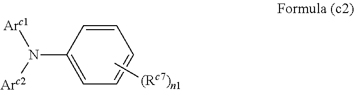

In the formula (c2), R^{c7} represents a hydrogen atom or a methyl group. n1 represents 1 or 2. Ar^{c1} and Ar^{c2} each independently represent a substituted or unsubstituted aryl group, —C₆H₄—C(R^{c8})═C(R^{c9})(R^{c10}), or —C₆H₄—CH═CH—CH═C(R^{c11})(R^{c12}); and R^{c8} to R^{c12} each independently represent a hydrogen atom, a substituted or unsubstituted alkyl group, or a substituted or unsubstituted aryl group.

In the formula (c2), a phenyl group is preferable as an aryl group represented by Ar^{c1} and Ar^{c2}.

In addition, in a case where an aryl group represented by Ar^{c1} and Ar^{c2} and an alkyl group or an aryl group represented by R^{c8} to R^{c12} have a substituent, examples of the substituent include a halogen atom, an alkyl group having 1 to 5 carbon atoms, an alkoxy group having 1 to 5 carbon atoms, and a substituted amino group which is substituted with an alkyl group having 1 to 3 carbon atoms.

A compound is shown below as an example of the compound represented by the formula (c2), but the exemplary embodiment is not limited thereto.

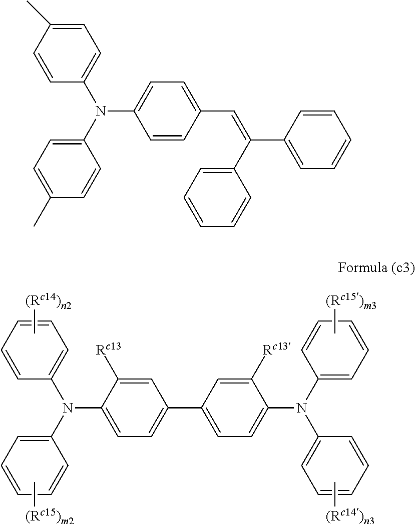

In the formula (c3), R^{c13} and R^{c13′} each independently represent a hydrogen atom, a halogen atom, an alkyl group having 1 to 5 carbon atoms, or an alkoxy group having 1 to 5 carbon atoms. R^{c14}, R^{c14′}, R^{c15}, and R^{c15′} each independently represent a hydrogen atom, a halogen atom, an alkyl group having 1 to 5 carbon atoms, an alkoxy group having 1 to 5 carbon atoms, an amino group substituted with an alkyl group having 1 to 2 carbon atoms, an aryl group, —C(R^{c16})═C(R^{c17})(R^{c18}), or —CH═CH—CH═C(R^{c19})(R^{c20}); and R^{c16} to R^{c20} each independently represent a hydrogen atom, an alkyl group, or an aryl group. m2, m3, n2, and n3 each independently represent an integer of 0 to 2.

The alkyl group, the alkoxy group, and the aryl group may have a substituent, and examples of the substituent include a halogen atom, an alkyl group having 1 to 5 carbon atoms, an alkoxy group having 1 to 5 carbon atoms, and a substituted amino group substituted with an alkyl group having 1 to 3 carbon atoms.

A compound is shown below as an example of the compound represented by the formula (c3), but the exemplary embodiment is not limited thereto.

### N,N′-diphenyl-N,N′-bis(3-methylphenyl)-[1,1′]biphenyl-4,4′-diamine

In terms of high sensitivity of the photoreceptor, among the above-described positive hole transporting materials, the compound represented by the formula (c1) is preferable.

Further, the above-described positive hole transporting materials may be used alone or in combination of two or more kinds thereof.

The content of the positive hole transporting material is in the range of 10% by weight to 98% by weight, preferably in the range of 60% by weight to 95% by weight, and more preferably in the range of 70% by weight to 90% by weight with respect to the binder resin.

In addition, the content of the positive hole transporting material described herein is the total content of the entire positive hole transporting material.

[Electron Transporting Material (D)]

An electron transporting material represented by the following formula (d) is applied as the electron transporting material.

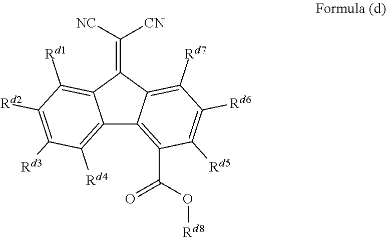

In the formula (d), R^{d1}, R^{d2}, R^{d3}, R^{d4}, R^{d5}, R^{d6}, and R^{d7} each independently represent a hydrogen atom, a halogen atom, an alkyl group, an alkoxy group, an aralkyl group, or an aryl group. R^{d8} represents an aralkyl group or an alkyl group.

In the formula (d), as the halogen atom represented by R^{d1} to R^{d7}, a fluorine atom, a chlorine atom, a bromine atom, or an iodine atom may be exemplified.

In the formula (d), as the alkyl group represented by R^{d1} to R^{d7}, an alkyl group which is linear or branched and has 1 to 4 carbon atoms (preferably 1 to 3 carbon atoms) may be exemplified, and specific examples thereof include a methyl group, an ethyl group, an n-propyl group, an isopropyl group, an n-butyl group, and an isobutyl group.

In the formula (d), as the alkoxy group represented by R^{d1} to R^{d7}, an alkoxy group having 1 to 4 carbon atoms (preferably 1 to 3 carbon atoms) may be exemplified, and specific examples thereof include a methoxy group, an ethoxy group, a propoxy group, and a butoxy group.

In the formula (d), as the aralkyl group represented by R^{d1} to R^{d7}, a group represented by —R—Ar¹ may be exemplified. In this case, R represents an alkylene group and Ar¹ represents an aryl group. Specific examples thereof include a benzyl group.

In the formula (d), as the aryl group represented by R^{d1} to R^{d7}, a phenyl group or a tolyl group may be exemplified.

Among these, a phenyl group is preferable.

In the formula (d), as the alkyl group represented by R^{d8}, a linear alkyl group having 5 to 10 carbon atoms or a branched alkyl group having 5 to 10 carbon atoms may be exemplified.

Examples of the linear alkyl group having 5 to 10 carbon atoms include a methyl group, an ethyl group, an n-propyl group, an n-butyl group, an n-pentyl group, an n-hexyl group, an n-heptyl group, an n-octyl group, an n-nonyl group, and an n-decyl group.

Examples of the branched alkyl group having 5 to 10 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

In the formula (d), as the aralkyl group represented by R^{d8}, a group represented by —R′—Ar² may be exemplified. In this case, R′ represents an alkylene group and Ar² represents an aryl group.

Examples of the alkylene group represented by R′ include a linear or branched alkylene group having 1 to 8 carbon atoms, a methylene group, an ethylene group, an n-propylene group, an isopropylene group, an n-butylene group, an isobutylene group, a sec-butylene group, a tert-butylene group, an n-pentylene group, an isopentylene group, a neopentylene group, and a tert-pentylene group.

Examples of the aryl group represented by Ar² include a phenyl group, a methyl phenyl group, and a dimethyl phenyl group.

In the formula (d), specific examples of the aralkyl group represented by R^{d8} include a benzyl group, a methyl benzyl group, a dimethyl benzyl group, a phenyl ethyl group, a methyl phenyl ethyl group, a phenyl propyl group, and a phenyl butyl group.

From viewpoints of high sensitivity and preventing point defects of an image, an electron transporting material in which R^{d1} to R^{d7} each independently represent a hydrogen atom, a halogen atom, or an alkyl group and R^{d8} represents a linear alkyl group having 5 to 10 carbon atoms is preferable as the electron transporting material represented by the formula (d).

Hereinafter, compounds (d-1) to (d-15) will be shown as examples of the electron transporting material represented by the formula (d), but the examples are not limited thereto.

| Example | | | | | | | | |
|---|---|---|---|---|---|---|---|---|
| Com- | | | | | | | | |
| pound | R^{d1} | R^{d2} | R^{d3} | R^{d4} | R^{d5} | R^{d6} | R^{d7} | R^{d8} |
| (d-1) | H | H | H | H | H | H | H | n-C₇-H₅ |
| (d-2) | H | H | H | H | H | H | H | n-C₈H₁₇ |
| (d-3) | H | H | H | H | H | H | H | n-C₅H₁₁ |
| (d-4) | H | H | H | H | H | H | H | n-C₁₀H21 |
| (d-5) | Cl | Cl | Cl | Cl | Cl | Cl | Cl | n-C₇H₁₅ |
| (d-6) | H | Cl | H | Cl | H | Cl | Cl | n-C₇H₁₅ |
| (d-7) | CH₃ | CH₃ | CH₃ | CH₃ | CH₃ | CH₃ | CH₃ | n-C₇H₁₅ |
| (d-8) | C₄H₉ | C₄H₉ | C₄H₉ | C₄H₉ | C₄H₉ | C₄H₆ | C₄H₉ | n-C₇H₁₅ |
| (d-9) | CH₃O | H | CH₃O | H | CH₃O | H | CH₃0 | n-C₃H₁₇ |
| (d-10) | C₆H₅ | C₆H₅ | C₆H₅ | C₆H₅ | C₆H₅ | C₆H₅ | C₆H₅ | n-C₈H₁₇ |
| (d-11 ) | H | H | H | H | H | H | H | n-C₄H₉ |
| (d-12) | H | H | H | H | H | H | H | n-C₁₁H₂₃ |
| (d-13) | H | H | H | H | H | H | H | n-C₉H₁₉ |
| (d-14) | H | H | H | H | H | H | H | CH₂-CH |
| | | | | | | | | (C₂H₅)-C₄H₉ |
| (d-15) | H | H | H | H | H | H | H | (CH₂)₂-Ph |

In addition, the abbreviation in the compounds shown above indicates the following meaning.

Ph: a phenyl group

The content of the electron transporting material represented by the formula (d) is in the range of 10% by weight to 40% by weight, preferably in the range of 15% by weight to 30% by weight, and more preferably in the range of 20% by weight to 25% by weight with respect to the binder resin.

[Other Electron Transporting Materials]

In addition to the electron transporting material represented by the formula (d) shown above, other electron transporting materials may be used in combination within the range not damaging the function thereof. In this case, other electron transporting materials may preferably be used in combination in a content of 10% by weight or less with respect to the entire electron transporting materials.

Examples of other electron transporting materials include electron transporting materials, for example, a quinone-based compound such as p-benzoquinone, chloranil, bromanil, or anthraquinone; a fluorenone compound such as a tetracyanoquinodimethane-based compound or 2,4,7-trinitrofluorenone; a xanthone-based compound; a benzophenone-based compound; a cyanovinyl-based compound, and an ethylene-based compound.

These examples of other electron transporting materials may be used alone or in combination of two or more kinds thereof.

In addition, the content of the entire electron transporting material is 10% by weight to 70% by weight, preferably in the range of 15% by weight to 50% by weight, and more preferably in the range 20% by weight to 40% by weight with respect to the binder resin.

[Ratio of Positive Hole Transporting Material to the Electron Transporting Material]

The ratio of the positive hole transporting material to the electron transporting material is, in a weight ratio (positive hole transporting material/electron transporting material), is preferably in the range of 50/50 to 90/10 and more preferably in the range of 60/40 to 80/20.

In addition, in a case where other electron transporting materials are used in combination, the ratio is based on the total weight of the materials.

[Terphenyl Compound (E)]

A terphenyl compound (E) is added to the singlelayer type photosensitive layer in the present exemplary embodiment.

The corrosion of the surface of the conductive substrate may be prevented by means of using the terphenyl compound (E) together with the electron transporting material represented by the formula (d) shown above in the singlelayer type photosensitive layer.

It is preferable that the terphenyl compound (E) be a compound represented by the following formula (e1).

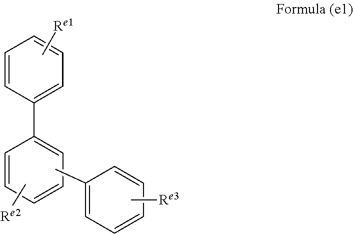

In the formula (e1), R^{e1}, R^{e2}, and R^{e3} each independently represent a hydrogen atom, a chlorine atom, a bromine atom, or a methyl group.

Among the compounds represented by the formula (e1) shown above, it is preferable that the terphenyl compound (E) be at least one of a compound represented by the following formula (e2) and a compound represented by the formula (e3).

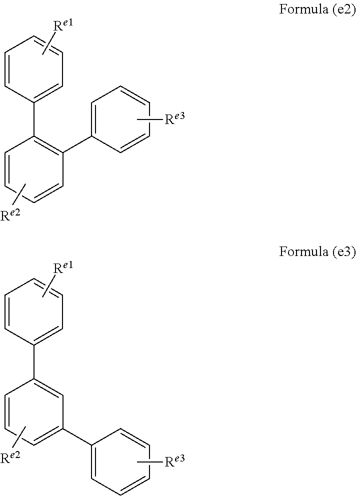

In the formulae (e2) and (e3), R^{e1}, R^{e2}, and R^{e3} each independently represent a hydrogen atom, a chlorine atom, a bromine atom, or a methyl group.

The content of the terphenyl compound may be in the range of 5% by weight to 30% by weight, preferably in the range of 10% by weight to 25% by weight, and more preferably in the range of 15% by weight to 20% by weight with respect to the binder resin.

[Other Additives]

The singlelayer type photosensitive layer may contain other known additives such as an antioxidant, a light stabilizer, and a heat stabilizer. Further, in a case where the singlelayer type photosensitive layer is a surface layer, the singlelayer photosensitive layer may contain fluorine resin particles, silicone oil, and the like.

—Formation of Singlelayer Type Photosensitive Layer—

The singlelayer type photosensitive layer is formed using a coating liquid for forming a photosensitive layer obtained by adding the above-described components to a solvent.

Examples of the solvent include normal organic solvents, for example, aromatic hydrocarbon solvents such as benzene, toluene, xylene, and chlorobenzene; ketone solvents such as acetone and 2-butanone; halogenated aliphatic hydrocarbon solvents such as methylene chloride, chloroform, and ethylene chloride; and cyclic or linear ether solvents such as tetrahydrofuran and ethyl ether. These solvents are used alone or in combination of two or more kinds thereof.

As a method of dispersing particles (for example, a charge generating material) in a coating liquid for forming a photosensitive layer, a media dispersing machine such as a ball mill, a vibration ball mill, an attritor, a sand mill, or a horizontal sand mill; or a media-less dispersing machine such as stirring, an ultrasonic dispersing machine, a roll mill, or a high-pressure homogenizer is used. As the high-pressure homogenizer, a collision system of dispersing particles through liquid to liquid collision or liquid to wall collision of a dispersion liquid in a high pressure state or a penetration system of dispersing particles through penetration of a fine flow path in a high pressure state may be exemplified.

Examples of a method of coating the undercoat layer with a coating liquid for forming a photosensitive layer include a dipping coating method, an extrusion coating method, a wire bar coating method, a spray coating method, a blade coating method, a knife coating method, and a curtain coating method.

The film thickness of the singlelayer type photosensitive layer is preferably set in the range of 5 μm to 60 μm and more preferably set in the range of 10 μm to 50 μm.

[Protective Layer]

The protective layer is provided on the photosensitive layer according to the necessity. The protective layer is provided for a purpose of preventing chemical change of the photosensitive layer at the time of charging or improving mechanical strength of the surface of the photoreceptor.

A known protective layer is applied as the protective layer, but a layer formed of a cured film (cross-linked film) may preferably be applied.

As the protective layer formed of a cured film (cross-linked film), a layer shown in 1) or 2) below may be exemplified.

1) A layer formed of a cured film of a composition containing a reactive group-containing charge transporting material having a reactive group and a charge transporting skeleton in the same molecule (that is, a layer containing a polymer or a cross-linked body of the reactive group-containing charge transporting material)

2) A layer formed of a cured film of a composition containing a non-reactive charge transporting material and a reactive group-containing non-charge transporting material having a reactive group without a charge transporting skeleton (that is, a layer containing a non-reactive charge transporting material and a polymer or a cross-linked body of the reactive group-containing non-charge transporting material)

Examples of the reactive group of the reactive group-containing charge transporting material include known reactive groups such as a chain polymerizable group, an epoxy group, —OH, —OR (provided that, R represents an alkyl group), —NH₂, —SH, —COOH, —SiR^{Q1}_{3-Qn}(OR^{Q2})_{Qn} (provided that, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3).

The chain polymerizable group is not particularly limited as long as it is a radically polymerizable functional group, and the chain polymerizable group is a functional group having a group containing at least a carbon double bond. Specific examples thereof include a group containing at least one selected from a vinyl group, a vinyl ether group, a vinyl thioether group, a styryl group, an acryloyl group, a methacryloyl group, and derivatives thereof and the like. Among these, from a viewpoint of excellent reactivity, it is preferable that the chain polymerizable group be a group containing at least one selected from a vinyl group, a styryl group, an acryloyl group, a methacryloyl group, and derivatives thereof.

The charge transporting skeleton of a reactive group-containing charge transporting material is not particularly limited as long as the charge transporting skeleton has a known structure in the electrophotographic photoreceptor and, for example, a skeleton derived from a nitrogen-containing positive hole transporting compound such as a triarylamine-based compound, a benzidine-based compound, or a hydrazine-based compound, having a structure conjugated with a nitrogen atom may be exemplified. Among these, a triarylamine skeleton is preferable.

The reactive group-containing charge transporting material including these reactive groups and the charge transporting skeleton, the non-reactive charge transporting material, and the reactive group-containing non-charge transporting material may be selected from known materials.

The protective layer may contain a known additive in addition to those described above.

Formation of the protective layer is not particularly limited and a known forming method may be used. For example, the protective layer is formed by forming a coated film with a coating liquid for forming a protective layer obtained by adding the above-described components to a solvent, drying the coated film, and performing a hardening treatment such as heating the dried film if necessary.

Examples of the solvent for preparing the coating liquid for forming a protective layer include an aromatic solvent such as toluene or xylene; a ketone-based solvent such as methyl ethyl ketone, methyl isobutyl ketone, or cyclohexanone; an ester-based solvent such as ethyl acetate or butyl acetate; an ether-based solvent such as tetrahydrofuran or dioxane; a cellosolve-based solvent such as ethylene glycol monomethyl ether; and an alcohol-based solvent such as isopropyl alcohol or butanol. These solvents may be used alone or in combination of two or more kinds thereof.

In addition, the coating liquid for forming a protective layer may be a solvent-free coating liquid.

Examples of a method of coating the photosensitive layer (for example, a charge transporting layer) with a coating liquid for forming a protective layer include normal methods such as a dipping coating method, an extrusion coating method, a wire bar coating method, a spray coating method, a blade coating method, a knife coating method, and a curtain coating method.

The film thickness of the protective layer is preferably set in the range of 1 μm to 20 μm and more preferably set in the range of 2 μm to 10 μm.

<Image Forming Apparatus and Process Cartridge>

An image forming apparatus of the present exemplary embodiment includes an electrophotographic photoreceptor; a charging unit that charges the surface of the electrophotographic photoreceptor; an electrostatic latent image forming unit that forms an electrostatic latent image on the surface of the charged electrophotographic photoreceptor; a developing unit that develops the electrostatic latent image formed on the surface of the electrophotographic photoreceptor using a developer including a toner and forms a toner image; and a transfer unit that transfers the toner image to the surface of a recording medium.

Further, as the electrophotographic photoreceptor, the electrophotographic photoreceptor according to the present exemplary embodiment described above is applied.

Examples of the image forming apparatus according to the present exemplary embodiment include known image forming apparatuses such as an apparatus including a fixing unit that fixes a toner image transferred to a surface of a recording medium; an apparatus having a direct transfer system of directly transferring a toner image formed on a surface of an electrophotographic photoreceptor to a recording medium; an apparatus having an intermediate transfer system of primarily transferring a toner image formed on a surface of an electrophotographic photoreceptor to a surface of an intermediate transfer member and then secondarily transferring the toner image transferred to the surface of the intermediate transfer member to a surface of a recording medium; an apparatus including a cleaning unit that performs cleaning of a surface of an electrophotographic photoreceptor after transferring a toner image and before charging; an apparatus including an erasing unit that performs erasing by irradiating a surface of an image holding member with erasing light after transferring a toner image and before charging; and an apparatus including a heating member of an electrophotographic photoreceptor for decreasing the relative temperature by increasing the temperature of the electrophotographic photoreceptor.

In the case of the apparatus having an intermediate transfer system, the transfer unit has a configuration including an intermediate transfer member to a surface of which a toner image is transferred; a primary transfer unit that primarily transfers the toner image formed on a surface of an image holding member to the surface of the intermediate transfer member; and a secondary transfer unit that secondarily transfers the toner image transferred to the surface of the intermediate transfer member to the surface of the recording medium.

The image forming apparatus according to the present exemplary embodiment may be any one of an image forming apparatus having a dry developing system and an image forming apparatus having a wet developing system (developing system using a liquid developer).

In addition, in the image forming apparatus according to the present exemplary embodiment, a portion including the electrophotographic photoreceptor may have a cartridge structure (process cartridge) which is detachable from the image forming apparatus. As the process cartridge, a process cartridge including the electrophotographic photoreceptor according to the present exemplary embodiment is preferably used. Moreover, in addition to the electrophotographic photoreceptor, the process cartridge may include at least one selected from a group consisting of, for example, a charging unit, an electrostatic latent image forming unit, a developing unit, and a transfer unit.

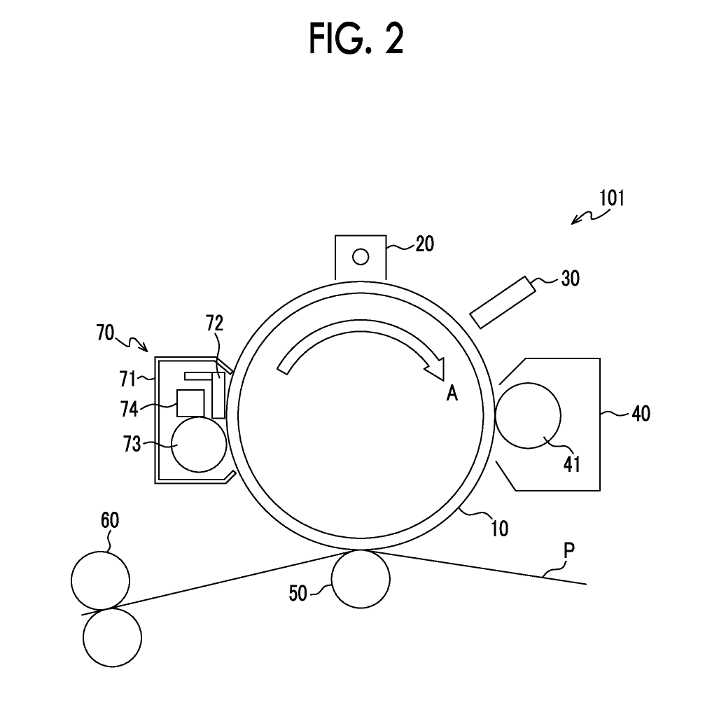

Hereinafter, with reference to FIG. 2, the image forming apparatus according to the present exemplary embodiment will be described in detail.

Here, FIG. 2 is a view schematically illustrating a configuration the image forming apparatus according to the present exemplary embodiment.

An image forming apparatus 101 according to the present exemplary embodiment includes, as illustrated in FIG. 2, an electrophotographic photoreceptor 10 that rotates in a clockwise direction as indicated by an arrow A; a charging device 20 (an example of the charging unit) that is provided over the electrophotographic photoreceptor 10 relative to the electrophotographic photoreceptor 10 and charges the surface of the electrophotographic photoreceptor 10, an exposure device 30 (an example of an electrostatic latent image forming unit) that exposes the surface of the electrophotographic photoreceptor 10 charged by the charging unit 20 and forms an electrostatic latent image; a developing device 40 (an example of a developing unit) that allows a toner contained in a developer to be attached to the electrostatic latent image formed by the exposure device 30 to form a toner image on the surface of the electrophotographic photoreceptor 10; a transfer device 50 that allows recording paper P (an example of a recorded medium) to be charged to have a polarity different from the charged polarity of the toner and transfers a toner image on the electrophotographic photoreceptor 10 to the recording paper P; and a cleaning device 70 (an example of a toner removing unit) that performs cleaning of the surface of the electrophotographic photoreceptor 10. Further, a fixing device 60 that feeds the recording paper P on which the toner image is formed and fixes the toner image is provided.

Hereinafter, details of the constituent members in the image forming apparatus 101 according to the present exemplary embodiment will be described.

[Charging Device]

Examples of the charging device 20 include a conductive charging roller, a charging brush, a charging film, a charging rubber blade, and a contact type charger using a charging tube or the like.

Further, examples of the charging device 20 also include known chargers such as a non-contact type roller charger, a scorotron charger, and a corotron charger using corona discharge.

[Exposure Device]

As the exposure device 30, an optical system device that exposes the surface of the electrophotographic photoreceptor 10 in an image pattern to light such as semiconductor laser light, LED light, or liquid crystal shutter light may be exemplified. It is preferable that the wavelength of a light source be in the range of a spectral sensitivity area of the electrophotographic photoreceptor 10. As the wavelength of the semiconductor laser, for example, near infrared having an oscillation wavelength at around 780 nm is preferable. However, the wavelength is not limited thereto, and laser having an oscillation wavelength of approximately 600 nm or, as blue laser, laser having an oscillation wavelength of 400 nm to 450 nm may be used. Further, as the exposure device 30, a surface emitting type laser light source outputting multi-beams is effective for forming color images.

[Developing Device]

As the developing device 40, a device having a configuration in which a developing roll 41 arranged so as to face the electrophotographic photoreceptor 10 in a developing area is included in a container accommodating a developer formed of two components of a toner and a carrier may be exemplified. The developing device 40 is not particularly limited as long as the device performs developing using a developer formed of two components, and a known configuration is employed.

Here, a developer used for the developing device 40 may be a single-component developer formed of a toner or a two-component developer formed of a toner and a carrier.

[Transfer Device]

Examples of the transfer device 50 include known transfer chargers such as a contact type transfer charger using a belt, a roller, a film, and a rubber blade, a scorotron transfer charger, and a corotron transfer charger using corona discharge.

[Cleaning Device]

The cleaning device 70 includes a housing 71, a cleaning blade 72, and a cleaning brush 73 arranged on the downstream side of the cleaning blade 72 in the rotation direction of the electrophotographic photoreceptor 10. Further, the cleaning brush 73 is arranged in such a way that, for example, a solid lubricant 74 is brought into contact with the cleaning brush 73.

Hereinafter, an operation of the image forming apparatus 101 according to the present exemplary embodiment will be described. First, the electrophotographic photoreceptor 10 is positively charged by the charging device 20 when rotating along a direction indicated by an arrow a.

The electrophotographic photoreceptor 10 whose surface is positively charged by the charging device 20 is exposed by the exposure device 30 and a latent image is formed on the surface thereof.

When a portion on which a latent image is formed in the electrophotographic photoreceptor 10 approaches the developing device 40, a toner is attached to the latent image by the developing device 40 (developing roller 41) and a toner image is formed.

When the electrophotographic photoreceptor 10 on which a toner image is formed further rotates in the direction indicated by the arrow a, the toner image is transferred to the recording paper P by the transfer device 50. In this manner, a toner image is formed on the recording paper P.

Next, the surface of the electrophotographic photoreceptor 10 is cleaned by the cleaning device 70. Then the surface thereof is charged again by the charging device 20 and then the next cycle (image process) is performed.

A toner image is fixed, by the fixing device 60, to the recording paper P on which an image is formed.

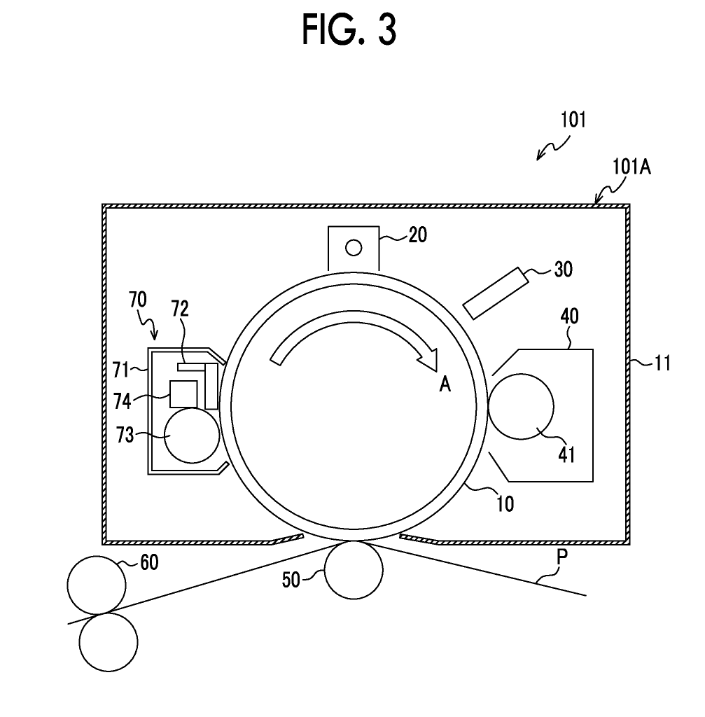

In addition, the image forming apparatus according to the present exemplary embodiment may have a configuration of the image forming apparatus 101 as illustrated in FIG. 3. Here, FIG. 3 is a view schematically illustrating another image forming apparatus according to the present exemplary embodiment.

The image forming apparatus 101 according to the present exemplary embodiment may include a process cartridge 101A integrally accommodating the electrophotographic photoreceptor 10, the charging device 20, the exposure device 30, the developing device 40, and the cleaning device 70 in the housing 11 as illustrated in FIG. 3. The process cartridge 101A integrally accommodates plural members and is detachable from the image forming apparatus 101.

The configuration of the process cartridge 101A is not limited thereto. For example, the process cartridge 101A may include at least the electrophotographic photoreceptor 10 and the transfer device 50 and may further include at least one selected from the charging device 20, the exposure device 30, the developing device 40, and the cleaning device 70.

Further, the configuration of the image forming apparatus 101 according to the present exemplary embodiment is not limited to the above. For example, the image forming apparatus 101 may include a first erasing device which arranges a polarity of the remaining toner and is provided for easily erasing using a cleaning brush in the vicinity of the electrophotographic photoreceptor 10, which is on the downstream side of the transfer device 50 in the rotation direction of the electrophotographic photoreceptor 10 and on the upstream side of the cleaning device 70 in the rotation direction of the electrophotographic photoreceptor; or may include a second erasing device that erases the charge of the surface of the electrophotographic photoreceptor 10 on the downstream side of the cleaning device 70 in the rotation direction of the electrophotographic photoreceptor and on the upstream side of the charging device 20 in the rotation direction of the electrophotographic photoreceptor.

Further, the configuration of the image forming apparatus 101 according to the present exemplary embodiment is not limited to the above, and known configurations, for example, an image forming apparatus having an intermediate transfer system of transferring a toner image formed on the electrophotographic photoreceptor 10 to the intermediate transfer member and then transferring the toner image to the recording paper P or an image forming apparatus having a tandem system may be employed.

### EXAMPLES

Hereinafter, the present invention will be described in detail based on Examples and Comparative Examples, but the present invention is not limited to the following Examples.

Further, “part” and “%” described below are on a weight basis unless otherwise noted.

### Example 1

### Preparation of Photoreceptor (1)

A mixture obtained by mixing 3 parts by weight of a V shaped hydroxy gallium phthalocyanine pigment having diffraction peaks at least positions at bragg angles (2θ±0.2°), of an X-ray diffraction spectrum using a CuKα characteristic X-ray, of 7.3°, 16.0°, 24.9°, and 28.0°, as a charge generating material; 44 parts by weight of a bisphenol Z polycarbonate resin (viscosity average molecular weight: 50000) as a binder resin; 11 parts by weight of the electron transporting material listed in Table 1; 30 parts by weight of the positive hole transporting material listed in Table 1; 8.8 parts by weight of the terphenyl compound listed in Table 1; and 250 parts by weight of tetrahydrofuran as a solvent was dispersed in a sand mill using a glass bead having a diameter of 1 mmφ for 4 hours, thereby obtaining a coating liquid for forming a photosensitive layer.

An aluminum substrate having dimensions of a diameter of 30 mm and a length of 244.5 mm was coated with the coating liquid for forming a photosensitive layer using a dipping coating method, and the substrate was dried and cured at 140° C. for 30 minutes, thereby a singlelayer type photosensitive layer having a thickness of 38 μm was formed.

After the above-described processes, an electrophotographic photoreceptor (photoreceptor 1) was prepared.

### Examples 2 to 17 and Comparative Examples 1 to 19

### Preparation of photoreceptors 2 to 17 and photoreceptors C1 to C19 for comparison

Electrophotographic photoreceptors (photoreceptors 2 to 17 and photoreceptors C1 to C19 for comparison) were prepared in the same manner as that of the photoreceptor 1 except that the kinds of the positive hole transporting material, the electron transporting material, and the terphenyl compound were appropriately changed according to Table 1 and the amount of the binder resin was changed such that the contents of the electron transporting material and the terphenyl compound with respect to the binder resin were adjusted to the values listed in Table 1.

Here, the contents of the electron transporting material and the terphenyl compound in Table 1 respectively indicate the contents with respect to the binder resin.

<Evaluation>

In regard to the electrophotographic photoreceptors obtained in the above-described manner, evaluation was performed as follows. The results are collectively listed in Table 1.

[Evaluation of Sensitivity]

Evaluation of the sensitivity of the photoreceptor was performed based on the half decay exposure at the time when the photoreceptor was charged at +800 V.

Specifically, the photoreceptor was charged at +800 V in an environment of 20° C. and 40% RH using an electrostatic copying paper testing device (electrostatic analyzer EPA-8100, manufactured by Kawaguchi Electric Co., Ltd.), and light of a tungsten lamp was made into monochromatic light of 800 nm using a monochromator, and then the surface of the photoreceptor was irradiated with the monochromatic light such that the intensity of the light was adjusted to 1 μW/cm².

In addition, the potential of the surface of the photoreceptor immediately after the charging was set as a surface potential V₀ (V), and a half decay exposure E½ (μJ/cm²) whose surface potential was ½×V₀ (V) due to irradiation of the surface of the photoreceptor with light was measured.

The criteria of the evaluation are as follows.

—Criteria of Evaluation—

1: The half decay exposure was in the range of 0.10 μJ/cm² to 0.15 μJ/cm².

2: The half decay exposure was in the range of more than 0.15 μJ/cm² to 0.175 μJ/cm².

3: The half decay exposure was in the range of more than 0.175 μJ/cm² to 0.20 μJ/cm².

4: The half decay exposure was more than 0.20 μJ/cm².

[Evaluation of Image Quality]

The evaluation of image quality was performed as follows by mounting the obtained photoreceptor on a modified machine of HL5340D (manufactured by Brother, Inc.).

50% Halftone images were printed at 10 sheets/min and 2000 sheets/day using the modified machine of HL5340D (manufactured by Brother, Inc.) in an environment of room temperature of 32° C. and a humidity of 85%, and 10000 sheets of images were printed out.

Subsequently, the operation of the machine was stopped for a night and evaluation was performed based on the following criteria in regard to color points on an image of the first white paper in the next morning.

—Evaluation Criteria—

1: Color points were not generated.

2: 1 to 9 color points are confirmed, but which is not practically a problem.

3: 10 or more color points are confirmed, and practical problems are generated.

[Evaluation of Corrosion of Aluminum Substrate]

After the above-described evaluation of image quality, color points generated according to the pitch of the photoreceptor were confirmed and sites of the surface of the photoreceptor corresponding to the color points were specified.

The photosensitive layer of the specified area was removed using tetrahydrofuran, the surface of the exposed aluminum substrate was observed using a microscope, and then evaluation was performed based on the following criteria.

—Evaluation Criteria—

1: Corrosion was not generated.

2: Corrosion was generated in one to three areas.

3: Corrosion was generated in four or five areas.

4: Corrosion was generated in six areas or more.

[Evaluation of Chemical Cracks]

0.5 mL of a hexane solution containing 1% by weight of oleic acid was sprayed on the photoreceptor, and the photoreceptor was left alone at room temperature for 2 weeks, and then generation of cracks on the surface of the photoreceptor was observed and evaluation was performed based on the following criteria.

—Evaluation Criteria—

1: When the surface thereof was observed using a microscope, no problem found.

2: When the surface thereof was observed using a microscope, fine cracks were found, but practically no problem.

3: Cracks were visually confirmed.

TABLE 1

| | | Positive hole | Electron transporting material | | Terphenyl compound | | Evaluation | | | |
|---|---|---|---|---|---|---|---|---|---|---|
| | Photoreceptor | transporting | | Content | | Content | | Color | Corrosion of | Chemical |
| | No. | material | Type | (% by weight) | Type | (% by weight) | Sensitivity | points | substrate | cracks |
| Example 1 | 1 | HT-1 | ET-1 | 25 | 1-1 | 20 | 1 | 1 | 1 | 1 |
| Example 2 | 2 | HT-1 | ET-1 | 25 | 1-2 | 25 | 1 | 1 | 1 | 1 |
| Example 3 | 3 | HT-1 | ET-1 | 10 | 1-2 | 20 | 1 | 1 | 1 | 1 |
| Example 4 | 4 | HT-1 | ET-1 | 40 | 1-1 | 25 | 1 | 1 | 1 | 1 |
| Example 5 | 5 | HT-1 | ET-2 | 10 | 1-2 | 20 | 1 | 1 | 1 | 1 |
| Example 6 | 6 | HT-1 | ET-2 | 40 | 1-2 | 25 | 1 | 1 | 1 | 1 |
| Example 7 | 7 | HT-1 | ET-2 | 25 | 1-2 | 20 | 1 | 1 | 1 | 1 |
| Example 8 | 8 | HT-2 | ET-1 | 10 | 1-2 | 20 | 2 | 1 | 1 | 1 |
| Example 9 | 9 | HT-2 | ET-1 | 40 | 1-1 | 20 | 2 | 2 | 1 | 1 |
| Example 10 | 10 | HT-3 | ET-1 | 10 | 1-1 | 20 | 2 | 1 | 1 | 1 |
| Example 11 | 11 | HT-3 | ET-1 | 40 | 1-2 | 20 | 2 | 2 | 1 | 1 |
| Example 12 | 12 | HT-4 | ET-1 | 25 | 1-2 | 25 | 3 | 1 | 1 | 1 |
| Example 13 | 13 | HT-5 | ET-1 | 25 | 1-1 | 25 | 3 | 1 | 1 | 1 |
| Example 14 | 14 | HT-4 | ET-1 | 25 | 1-2 | 25 | 3 | 1 | 1 | 1 |
| Example 15 | 15 | HT-5 | ET-1 | 25 | 1-2 | 25 | 3 | 1 | 1 | 1 |
| Example 16 | 16 | HT-1 | ET-1 | 25 | 1-1 | 5 | 1 | 1 | 1 | 1 |
| Example 17 | 17 | HT-1 | ET-1 | 25 | 1-1 | 30 | 1 | 1 | 1 | 1 |
| Comparative | C1 | HT-1 | ET-1 | 25 | None | 0 | 1 | 2 | 4 | 1 |
| Example 1 | | | | | | | | | | |
| Comparative | C2 | HT-1 | ET-2 | 25 | None | 0 | 1 | 2 | 4 | 1 |
| Example 2 | | | | | | | | | | |
| Comparative | C3 | HT-2 | ET-2 | 25 | None | 0 | 1 | 2 | 4 | 1 |
| Example 3 | | | | | | | | | | |
| Comparative | C4 | HT-3 | ET-1 | 25 | None | 0 | 1 | 2 | 4 | 1 |
| Example 4 | | | | | | | | | | |
| Comparative | C5 | HT-1 | ET-1 | 10 | None | 0 | 1 | 2 | 4 | 1 |
| Example 5 | | | | | | | | | | |
| Comparative | C6 | HT-1 | ET-1 | 40 | None | 0 | 1 | 2 | 4 | 1 |
| Example 6 | | | | | | | | | | |
| Comparative | C7 | HT-1 | ET-1 | 5 | None | 0 | 2 | 3 | 4 | 2 |
| Example 7 | | | | | | | | | | |
| Comparative | C8 | HT-1 | ET-1 | 45 | None | 0 | 1 | 3 | 4 | 1 |
| Example 8 | | | | | | | | | | |
| Comparative | C9 | HT-1 | ET-1 | 5 | 1-2 | 25 | 2 | 2 | 2 | 2 |
| Example 9 | | | | | | | | | | |
| Comparative | C10 | HT-1 | ET-1 | 45 | 1-2 | 25 | 1 | 3 | 3 | 1 |
| Example 10 | | | | | | | | | | |
| Comparative | C11 | HT-1 | ET-1 | 45 | 1-1 | 25 | 1 | 3 | 3 | 1 |
| Example 11 | | | | | | | | | | |
| Comparative | C12 | HT-1 | CET-1 | 25 | None | 0 | 4 | 1 | 1 | 3 |
| Example 12 | | | | | | | | | | |
| Comparative | C13 | HT-2 | CET-2 | 25 | None | 0 | 4 | 1 | 1 | 3 |
| Example 13 | | | | | | | | | | |
| Comparative | C14 | HT-2 | CET-1 | 25 | None | 0 | 4 | 1 | 1 | 3 |
| Example 14 | | | | | | | | | | |
| Comparative | C15 | HT-3 | CET-2 | 25 | None | 0 | 4 | 1 | 1 | 3 |
| Example 15 | | | | | | | | | | |
| Comparative | C16 | HT-1 | CET-2 | 25 | 1-2 | 25 | 4 | 1 | 1 | 1 |
| Example 16 | | | | | | | | | | |
| Comparative | C17 | HT-1 | CET-1 | 25 | 1-2 | 25 | 4 | 1 | 1 | 1 |
| Example 17 | | | | | | | | | | |
| Comparative | C18 | HT-2 | CET-1 | 25 | 1-2 | 25 | 4 | 1 | 1 | 1 |
| Example 18 | | | | | | | | | | |
| Comparative | C19 | HT-3 | CET-2 | 25 | 1-2 | 25 | 4 | 1 | 1 | 1 |
| Example 19 | | | | | | | | | | |

As understood from Table 1 above, it is understood that the photoreceptors of Examples containing an electron transporting material (D) represented by the formula (d) whose content is in the range of 10% by weight to 40% by weight with respect to the binder resin; and a terphenyl compound (E) have sensitivity higher than those of the photoreceptors of Comparative Examples, and corrosion of the aluminum substrate and generation of color points are prevented as compared to the photoreceptors of Comparative Examples.

Moreover, it is understood that generation of chemical cracks on the photoreceptors of Examples is prevented.

Hereinafter, the abbreviations in Table 1 will be described in detail.

—Positive Hole Transporting Material—

HT-1: compound (c1-1) provided as an example of the positive hole transporting material represented by the formula (c1)

HT-2: positive hole transporting material having the following structure

HT-3: N,N′-diphenyl-N,N′-bis(3-methylphenyl)-[1,1′]biphenyl-4,4′-diamine (compound represented by the formula (c3))

HT-4: positive hole transporting material having the following structure

HT-5: positive hole transporting material having the following structure

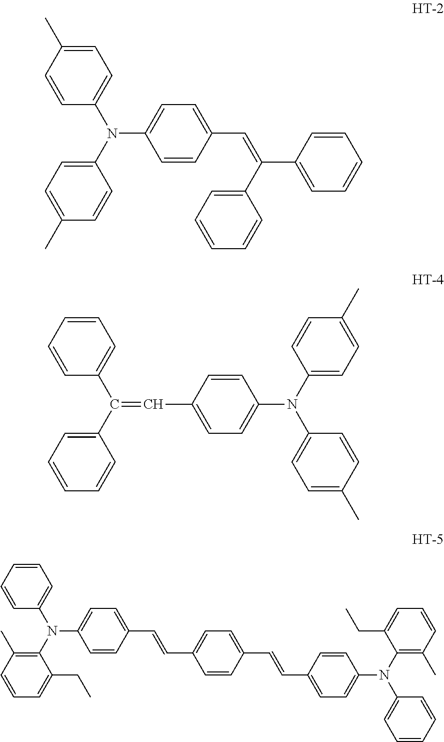 [SMILES: Cc1ccc(N(c2ccc(C)cc2)c2ccc(C=C(c3ccccc3)c3ccccc3)cc2)cc1 ; Cc1ccc(N(c2ccc(C)cc2)c2ccc(C=C(c3ccccc3)c3ccccc3)cc2)cc1 ; CCc1cccc(C)c1N(c1ccccc1)c1ccc(/C=C/c2ccc(/C=C/c3ccc(N(c4ccccc4)c4c(C)cccc4CC)cc3)cc2)cc1]

—Electron Transporting Material—

ET-1: compound (d-11) provided as an example of the electron transporting material represented by the formula (d)

ET-2: compound (d-12) provided as an example of the electron transporting material represented by the formula (d)

CET-1: electron transporting material having the following structure

CET-2: electron transporting material having the following structure

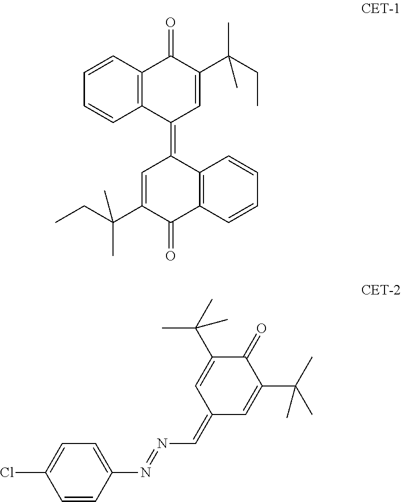 [SMILES: CCC(C)(C)C1=C/C(=C2/C=C(C(C)(C)CC)C(=O)c3ccccc32)c2ccccc2C1=O ; CC(C)(C)C1=CC(=C/N=N/c2ccc(Cl)cc2)C=C(C(C)(C)C)C1=O]

—Terphenyl Compound—

I-1: m-terphenyl (compound represented by the formula (e3))

I-2: o-terphenyl (compound represented by the formula (e2))

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate; and
a singlelayer type photosensitive layer that contains a binder resin (A), a charge generating material (B), a positive hole transporting material (C), an electron transporting material (D) whose content is in a range of 10% by weight to 40% by weight with respect to the binder resin (A) and which is represented by the following formula (d), and a terphenyl compound (E): 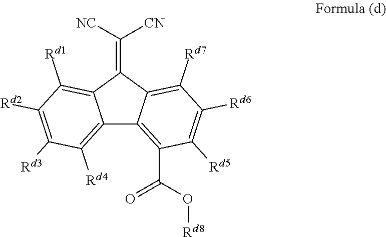
wherein in the formula (d), R^{d1}, R^{d2}, R^{d3}, R^{d4}, R^{d5}, R^{d6}, and R^{d7} each independently represent a hydrogen atom, a halogen atom, an alkyl group, an alkoxy group, an aralkyl group, or an aryl group; and R^{d8} represents an aralkyl group or an alkyl group.

2. The electrophotographic photoreceptor according to claim 1, wherein the electron transporting material (D) has a content of 15% by weight to 30% by weight with respect to the binder resin (A).

3. The electrophotographic photoreceptor according to claim 1, wherein the electron transporting material (D) has a content of 20% by weight to 25% by weight with respect to the binder resin (A).

4. The electrophotographic photoreceptor according to claim 1, wherein the terphenyl compound (E) has a content of 5% by weight to 30% by weight with respect to the binder resin (A).

5. The electrophotographic photoreceptor according to claim 1, wherein the terphenyl compound (E) has a content of 10% by weight to 25% by weight with respect to the binder resin (A).

6. The electrophotographic photoreceptor according to claim 1, wherein the terphenyl compound (E) has a content of 15% by weight to 20% by weight with respect to the binder resin (A).

7. The electrophotographic photoreceptor according to claim 1, wherein the terphenyl compound (E) is a compound represented by the following formula (e1): 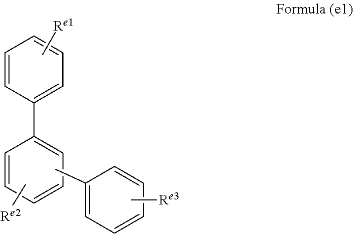
wherein in the formula (e1), R^{e1}, R^{e2}, and R^{e3} each independently represent a hydrogen atom, a chlorine atom, a bromine atom, or a methyl group.

8. The electrophotographic photoreceptor according to claim 1, wherein the terphenyl compound (E) is at least one of a compound represented by the following formula (e2) and a compound represented by the following formula (e3): 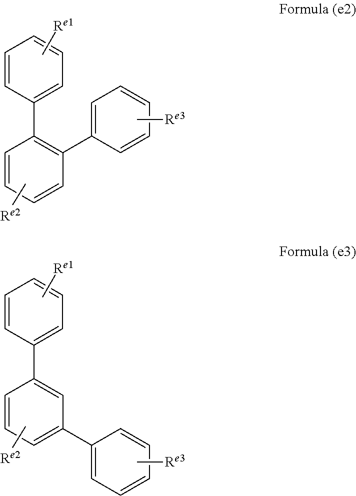
wherein in the formulae (e2) and (e3), R^{e1}, R^{e2}, and R^{e3} each independently represent a hydrogen atom, a chlorine atom, a bromine atom, or a methyl group.

9. The electrophotographic photoreceptor according to claim 1, wherein the positive hole transporting material (C) is at least one of a compound represented by the following formula (c1), a compound represented by the following formula (c2), and a compound represented by the following formula (c3): 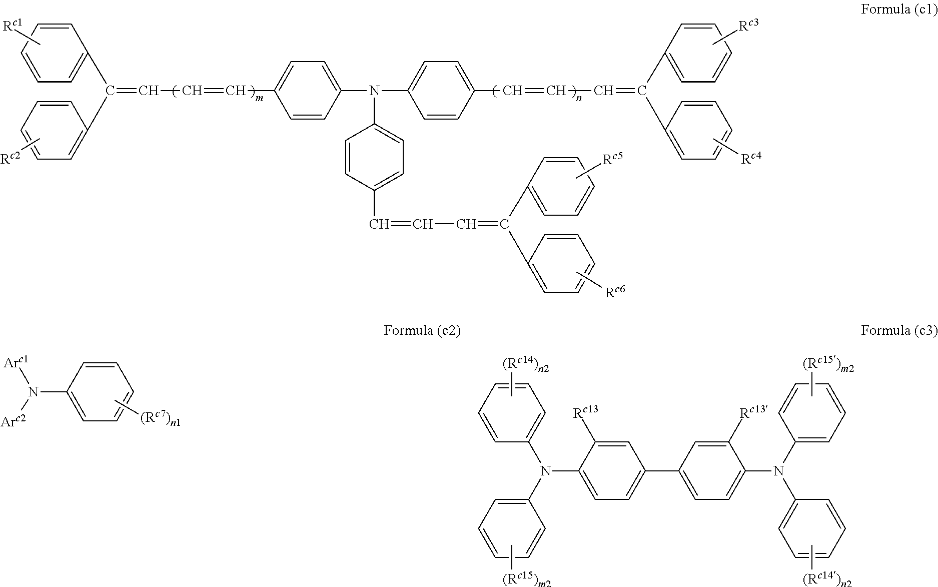
wherein in the formula (c1), R^{c1}, R^{c2}, R^{c3}, R^{c4}, R^{c5}, and R^{c6} each independently represent a hydrogen atom, an alkyl group, an alkoxy group, a phenoxy group, a halogen atom, or a phenyl group that may have a substituent selected from an alkyl group, an alkoxy group, and a halogen atom; and m and n each independently represent 0 or 1,
in the formula (c2), R^{c7} represents a hydrogen atom or a methyl group; n1 represents 1 or 2; Ar^{c1} and Ar^{c2} each independently represent an aryl group, —C₆H₄—C(R^{c8})═C(R^{c9})(R^{c10}), or —C₆H₄—CH═CH—CH═C(R^{c11})(R^{c12}); and R^{c8} to R^{c12} each independently represent a hydrogen atom, an alkyl group, or an aryl group, and
in the formula (c3), R^{c13} and R^{c13′} each independently represent a hydrogen atom, a halogen atom, an alkyl group having 1 to 5 carbon atoms, or an alkoxy group having 1 to 5 carbon atoms; R^{c14}, R^{c14′}, R^{c15}, and R^{c15′} each independently represent a hydrogen atom, a halogen atom, an alkyl group having 1 to 5 carbon atoms, an alkoxy group having 1 to 5 carbon atoms, an amino group substituted with an alkyl group having 1 to 2 carbon atoms, an aryl group, —C(R^{c16})═C(R^{c17})(R^{c18}), or —CH═CH—CH═C(R^{c19})(R^{c20}); R^{c16} to R^{c20} each independently represent a hydrogen atom, an alkyl group, or an aryl group; and m2, m3, n2, and n3 each independently represent an integer of 0 to 2.

10. A process cartridge comprising:
the electrophotographic photoreceptor according to claim 1,
wherein the process cartridge is detachable from an image forming apparatus.

11. An image forming apparatus comprising:
the electrophotographic photoreceptor according to claim 1;
a charging unit that charges a surface of the electrophotographic photoreceptor;
an electrostatic latent image forming unit that forms an electrostatic latent image on the surface of a charged electrophotographic photoreceptor;
a developing unit that develops the electrostatic latent image formed on the surface of the electrophotographic photoreceptor using a developer including a toner and forms a toner image; and
a transfer unit that transfers the toner image to a surface of a recording medium.
